(19) United States
(12) Patent Application Publication
(10) Pub. No.: US 2008/0240670 A1
(43) Pub. Date: Oct. 2, 2008

(54) PICTURE RECORDING SYSTEM AND PICTURE RECORDING AND REPRODUCING METHOD

(76) Inventors: Hiroki Miyamoto, Fujisawa (JP); Masato Suzuki, Yokohama (JP); Keita Asakura, Yokohama (JP); Takahiro Iwata, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/056,599

(22) Filed: Mar. 27, 2008

(30) Foreign Application Priority Data
Mar. 30, 2007 (JP) 2007-090192

(51) Int. Cl. H04N 5/91

(52) U.S. Cl. 386/46

(57) ABSTRACT

The present invention makes it possible to provide a reproduction resource even in an HDD recorder in which a plurality of storage processes is performed and no resource for providing the reproduction service exists. In order for realizing the above advantage, when the shortage of the reproduction resource occurs in a picture recording process, the picture recording process of the HDD recorder to which a content reproduction request is issued is switched to another HDD recorder, thereby providing the resource for content reproduction. Further, the content data stored in a dispersed manner by distributing the picture recording process is managed uniformly by recording the recording locations of the contents, which is divided and recorded, for every content data. Thus, it becomes possible to provide the content to the equipment issuing the reproduction request as a single content.

### CLAIM OF PRIORITY

The present application claims priority from Japanese application serial no. P2007-090192, filed on Mar. 30, 2007, the content of which is hereby incorporated by reference into this application.

### BACKGROUND OF THE INVENTION

1. Technical Field

The present invention relates to a technology in a system composed of a plurality of information processing devices communicating data via a communication network and for performing recording and reproducing of picture information among the plurality of devices.

2. Related Art

In recent years, AV household electrical appliances such as HDD recorders or TV equipped with a local area network (LAN) interface have grown popular. Although such appliances, in the past, have had a principal purpose of application of data broadcasting via a network, since the Digital Living Network Alliance (DLNA) has been established and network delivery of broadcast programs is now under review, a function of transmitting/receiving motion picture data via a LAN interface is expected in the future.

According to the DLNA described above, interoperability is assured even between appliances produced by different companies providing the appliances are compliant thereto. Specifically, streaming reproduction of the motion picture data stored in a Digital Media Server (DMS) of the DLNA by a Digital Media Player (DMP) of the DLNA is possible. Further, the DLNA Expanded has a specification capable of performing transfer of the motion picture data.

For example, in JP-A-2004-158969, there is proposed a system which uses the appliance cooperation technology described above and is arranged to allow resources (e.g., a tuner, capacity of the HDD, or processing capacity of the CPU) provided to an HDD recorder and so on to be independently used by, for example, other appliances via the network. Thus, even in the case in which the capacity of the local HDD provided to one HDD recorder is too small to provide an enough area for picture recording, the picture can be stored in another HDD recorder via the network.

### SUMMARY OF THE INVENTION

In the related art described in JP-A-2004-158969, there might occur a condition that a plurality of processing requests is concentrated in one appliance, the resources of the appliance accommodating the requests become lacking, and therefore some of the processing requests need to be rejected. As an example, there can be cited the case in which a TV and an HDD recorder both equipped with the DLNA exist on the network, and the HDD recorder receives a reproduction request to the motion picture data stored therein from the TV while the HDD recorder executing a picture recording process. On this occasion, the HDD in the HDD recorder is occupied by the picture recording processing, and therefore the response to the reproduction request from the outside is not possible.

Further, although in the case in which the capacity of the HDD has been overflowing while performing picture recording in one HDD recorder, which is a local HDD recorder A, it is possible to transmit the motion picture data of the program to another HDD recorder B on the network to store it in the HDD of the HDD recorder B, there arises a problem that the motion picture data of the program divided and stored in the separate HDD recorders are treated as separate motion picture data of the program, and the user needs to present a reproduction request explicitly selecting the divided motion picture data of the program when viewing the motion picture data.

The invention is for solving the problem described above and providing a picture recording/reproducing system capable of performing picture reproduction and picture recording while consolidating the resources without limitations in reproducing pictures.

In order for solving the problem described above, a picture system according to an embodiment of the invention for performing recording and reproduction of motion picture data via a network includes a first picture recording device for performing one of reception and recording of motion picture data, a second picture recording device for performing one of reception and recording of motion picture data, a reproduction device for performing reproduction of the motion picture data recorded in one of the first and second picture recording devices, a network for connecting the first picture recording device, the second picture recording device, and the reproduction device, and performing communication of the motion picture data, a motion picture data information recording section for storing a motion picture data information management table for recording a recording location of picture recording data for each of the picture recording data, and a motion picture data storage control section, in response to a reproduction request of the motion picture data stored in the first picture recording device from the reproduction device while the first picture recording device is receiving the motion picture data and performing recording, for transferring the motion picture data, which the first picture recording device receives on and after the reproduction request, to the second picture recording device, recording the motion picture data in the second picture recording device, and updating the recording location of the picture recording data in the motion picture data information management table.

Further, in the picture system according to the embodiment of the invention, the first picture recording device includes motion picture data reproduction control means for, when the reproduction device requests the motion picture data to the first picture recording device in order for performing reproduction of the motion picture data recorded in the first picture recording device, obtaining access information representing the recording location of the motion picture data to be reproduced with reference to the motion picture data information management table and notifying the reproduction device of the access information, and the reproduction device obtains the motion picture data based on the access information notified from the motion picture data reproduction control means, and reproduces the motion picture data.

Further, in the picture system according to the embodiment of the invention, the first picture recording device includes motion picture data reproduction control means for, when the reproduction device requests the motion picture data to the first picture recording device in order for performing reproduction of the motion picture data recorded in the first picture recording device, obtaining access information representing the recording location of the motion picture data to be reproduced with reference to the motion picture data information management table, obtaining the motion picture data based on the obtained access information, and reproducing the motion picture data, and the reproduction device obtains the motion picture data notified from the motion picture data reproduction control means, and reproduces the motion picture data.

Still further, in the picture system according to the embodiment of the invention, the first picture recording device includes motion picture data reproduction control means for, prior to the reproduction device requests the motion picture data to the first picture recording device in order for performing reproduction of the motion picture data recorded in the first picture recording device, obtaining access information representing the recording location of the motion picture data to be reproduced with reference to the motion picture data information management table, obtaining the motion picture data from two or more of the recording locations based on the access information, and linking the obtained motion picture data to perform correction of the motion picture data.

According to the embodiment of the invention, even in the case in which the reproduction request is issued from the reproduction device to the motion picture data stored in the picture recording device unable to provide the resource for delivering the motion picture data busy with the picture recording process and so on in the network including two or more of the picture recording devices, it becomes possible to process the reproduction request, thus the picture recording and reproduction system without limitation in recording and reproducing pictures can be provided.

### BRIEF DESCRIPTION OF THE DRAWINGS

FIG. 1 is a picture recording system configuration diagram according to the present embodiment.

FIG. 2 is a hardware configuration diagram of a reproduction device according to the present embodiment.

FIG. 3 is a hardware configuration diagram of a picture recording device and a recording device according to the present embodiment.

FIG. 4 is a diagram showing an example of a structure of a motion picture data information management table according to the present embodiment.

FIG. 5 is a flowchart showing an example of an operation of the picture recording system when recording pictures in the present embodiment.

### DESCRIPTION OF THE PREFERRED EMBODIMENTS

An embodiment of the invention will be explained with reference to the accompanying drawings. The same signs and reference numerals will hereinafter be treated as having the same functions.

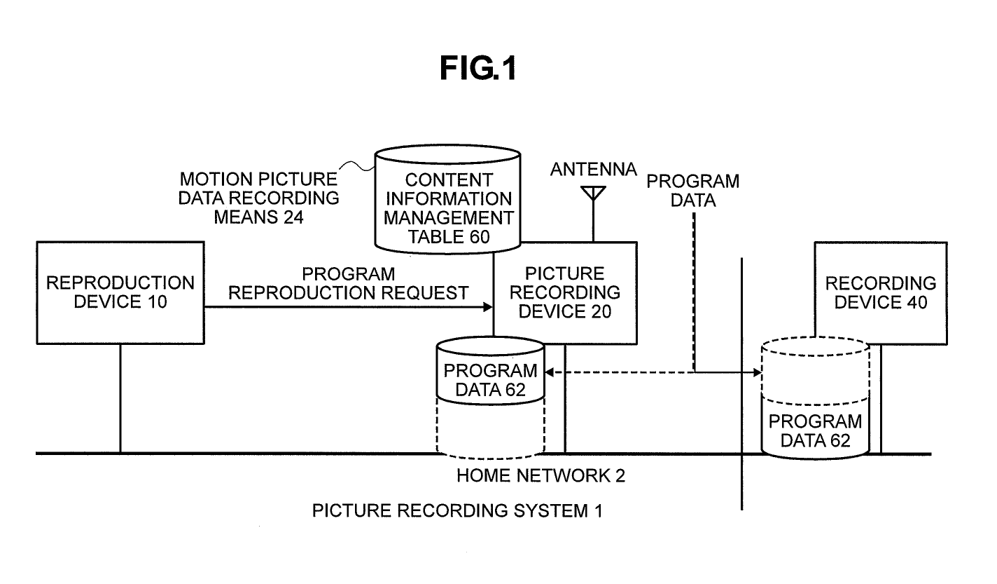

FIG. 1 is a diagram showing an example of the system configuration of a picture recording system 1 of the embodiment. In FIG. 1, the reference numeral 2 denotes a home network for connecting in-house appliances with a network, the reference numeral 10 denotes a reproduction device, the reference numeral 20 denotes a picture recording device, and the reference numeral 40 denotes a recording device.

The home network 2 connects the in-house processing devices such as a PC, an AV appliance, and a home electric appliance, which are connected to a router (not shown), using a wireless local area network (LAN), a wired LAN, bluetooth, or Ultra Wide Band (UWB) to enable the devices to perform data communication among each other.

It is assumed that each of the processing devices has an Internet Protocol (IP) address, uses the Universal Plug and Play (UPnP) and so on for each other's appliance control, and is capable of transmitting motion picture data or a part of the motion picture data using a protocol such as HTTP, RTP, or RTSP.

The reproduction device 10 is a device capable of controlling another device using, for example, the UPnP to obtain the Uniform Resource Identifier (URI) as the access destination of the motion picture data via the network, and allowing streaming viewing using the HTTP, RTP, or the like, and is realized by information-processing equipment such as a personal computer (PC), a hard disk drive (HDD) recorder, or a TV.

Here, the reproduction device 10 can have not only the function of the picture reproduction device as described above but also a function equivalent to that of the picture recording device 20 described later.

The picture recording device 20 is information-processing equipment such as a personal computer (PC), a hard disk drive (HDD) recorder, or a TV capable of controlling another device using, for example, the UPnP to obtain the URI as the access destination of the motion picture data using the network, and transmitting and receiving motion picture data using the HTTP, RTP, or the like. It can record broadcasted pictures received via an antenna on the own HDD, a tape medium, or the like. Further, it has a database, described in detail later, for managing positional information of the recorded motion picture data and divided motion picture data. The recorded motion picture data can be transmitted to another picture recording device, the recording device, and the reproduction device via the network.

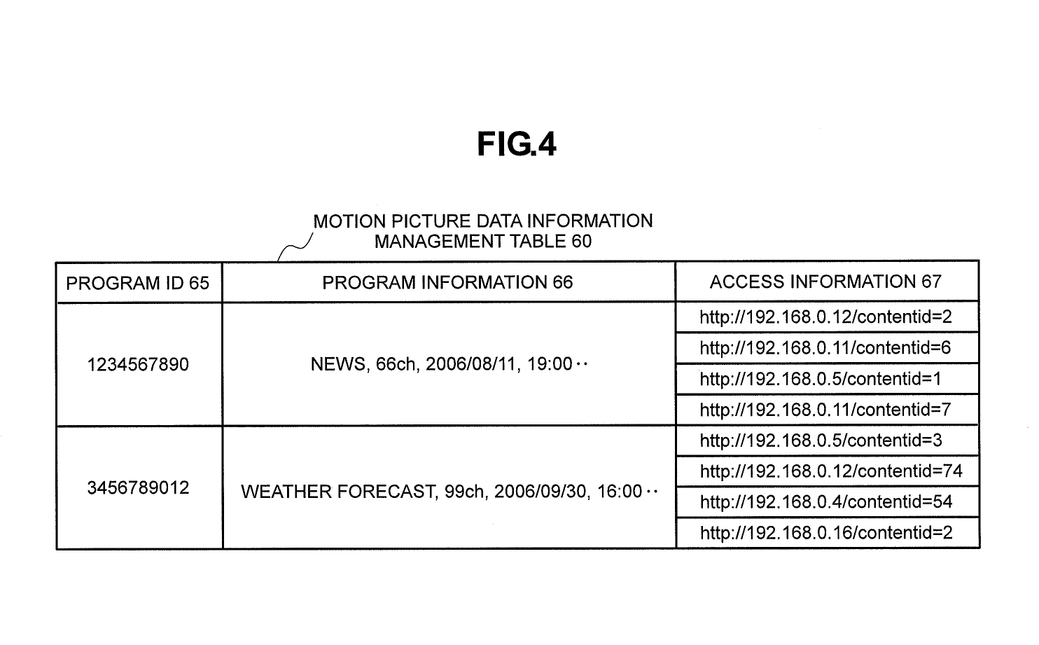

A motion picture data information management table 60, details of which are described in FIG. 4, is a table for recording correspondence between recorded programs and locations where the recorded programs are stored, and in the case in which a program is divided and stored in two or more of the picture recording devices 20 and the recording devices 40 in a dispersed manner, it forms a table for managing the URI for accessing each of the motion picture data 62 thus stored in a dispersed manner and the reproduction order thereof.

Here, the motion picture data 62 denotes motion image-motion picture data obtained from a broadcast wave received via the antenna and compressed into MPEG2, for example. Further, the motion picture data 62 includes the data obtained by dividing one program and stored in the picture recording devices 20 and the recording devices 40 on the network in a dispersed manner.

The recording device 40 is information-processing equipment such as a personal computer (PC), a hard disk drive (HDD) recorder, a TV, or a Network Attached Storage (NAS) capable of controlling another device using, for example, the UPnP to obtain the URI as the access destination of the motion picture data using the network, and transmitting and receiving motion picture data using the HTTP, RTP, or the like. It can be provided with only a function of storing the motion picture data transmitted thereto via the network in the local HDD or the like and delivering it in response to an acquisition request, or with a function equivalent to that of the picture recording device 20.

In the picture recording system explained in the present embodiment, when a reproduction request of the motion picture data stored in the picture recording device is received from another TV while recording is in progress in the picture recording device, and the picture recording device cannot provide the resource for newly transmitting the motion picture data, the resource for the picture recording device for delivering the motion picture data can be provided by asking the storing processing to the recording device or other picture recording devices. In the case in which there are two or more of recording devices capable of accommodating the storing processing on the network, the recording device to be asked to is selected based on the remaining capacity of the HDD and recording reservation information. A specific example will hereinafter be described in detail.

FIG. 4 shows a configuration example of the motion picture data information management table 60 according to the present embodiment. The motion picture data information management table 60 is mainly composed of program ID 65, program information 66, and access information 67. The program ID 65 is an identifier for uniquely specifying the program information of the recorded motion picture data in the picture recording device 20. The program information 66 is program information obtained from an Electronic Program Guide (EPG), and is used as explanatory information of the program to the user viewing the motion picture data.

The access information 67 is the URI of the divided motion picture data. It is enough to obtain the motion picture data uniquely specified by the recorded URI, and the description format of the URI is not particularly limited. The access information 67 is arranged in the order of generating the divided motion picture data, and by reproducing the data along the order of the access information, it is confirmed that the divided motion picture data can be reproduced as one motion picture data.

The configuration of the motion picture data information management table 60 is not limited to what is described above, but can be a configuration including recorded picture data information such as recording time or the number of frames of the divided motion picture data. By referring to such recorded picture data information, it becomes possible to easily perform trick reproduction such as skip reproduction.

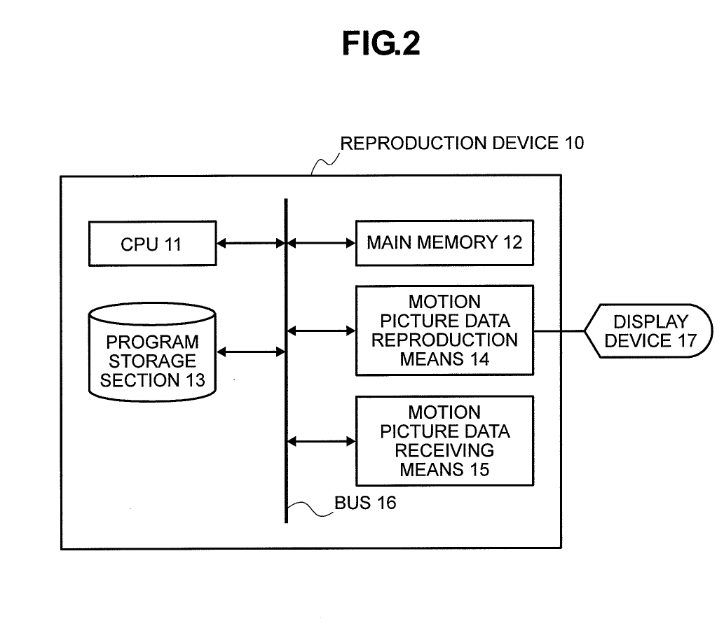

FIG. 2 is a hardware configuration diagram of the reproduction device 10 to which the present embodiment can be applied.

As shown in FIG. 2, the reproduction device 10 is composed at least of a CPU 11, a main memory 12, a program storage section 13, motion picture data reproduction means 14, motion picture data receiving means 15, and a bus 16. The constituents are connected to each other by the bus 15 so as to be able to communicate necessary information among the constituents.

The CPU 11 performs a predetermined operation in accordance with the program previously stored in the main memory 12 and the program storage section 13. The main memory 12 functions as a work area, and is means for storing the necessary program, at the same time, and can be realized by a random access memory (RAM) as the former case or a read only memory (ROM) as the latter case, for example.

The program storage section 13 is means for storing a program for providing the user with a Graphical User Interface (GUI) and so on of the reproduction device 10, and can be realized by, for example, a hard disk drive (HDD), an optical disk, or a flash memory.

The motion picture data reproduction means 14 has a function of decoding the motion picture data obtained by the motion picture data receiving means 15 and displaying it on a display device 17 such as a liquid crystal display, a cathode-ray tube (CRT) display, or a plasma display.

The motion picture data receiving means 15 is capable of receiving the motion picture data, which exists in the picture recording device or a recording device existing on the network, using the URI obtained from the picture recording device and so on via the network, and transmitting the motion picture data to the motion picture data reproduction means 14. As a more specific example of the present means, an HTTP client can be cited.

Although the motion picture data reproduction means 14 and the motion picture data receiving means 15 are assumed to be installed as hardware, they can be installed as software if possible.

The display device 17 is capable of displaying a picture transmitted from the motion picture data reproduction means 14. As a specific device used as the display device 17, a liquid crystal display, a CRT display, and a plasma display can be cited.

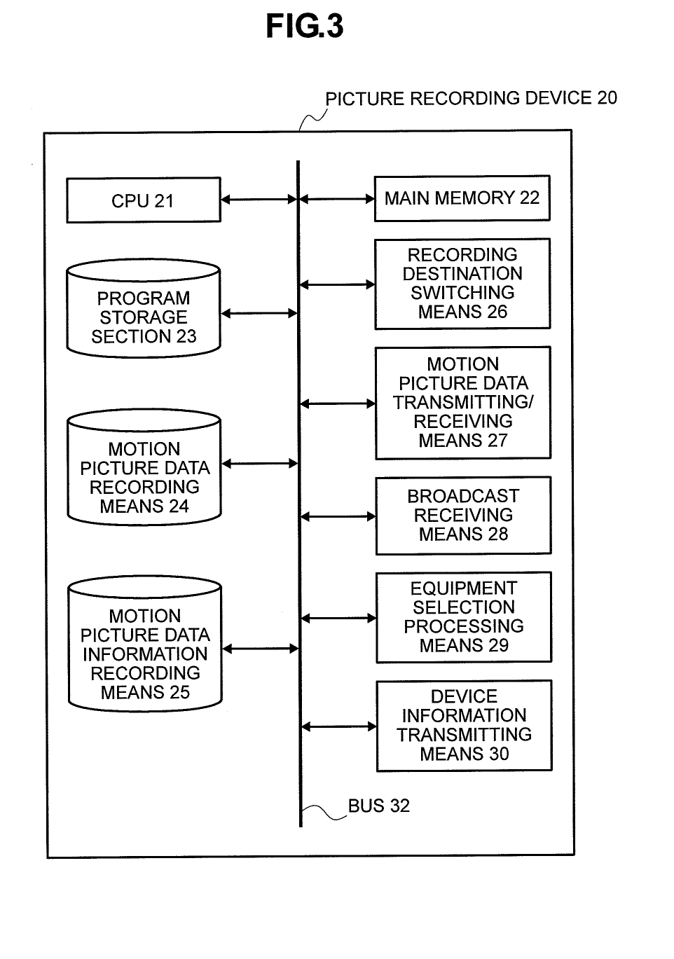

FIG. 3 is a hardware configuration diagram of the picture recording device 20 to which the present embodiment can be applied. As shown in FIG. 3, the picture recording device 20 is mainly composed of a CPU 21, a main memory 22, a program storage section 23, motion picture data recording means 24, motion picture data information recording means 25, recording destination switching means 26, motion picture data transmitting/receiving means 27, broadcast receiving means 28, and a bus 32. The constituents are connected to each other by the bus 32 so as to be able to communicate necessary information among the constituents.

The CPU 21 performs a predetermined operation in accordance with the program previously stored in the main memory 22 and the program storage section 23. The main memory 22 functions as a work area, and is means for storing the necessary program, at the same time, and can be realized by a random access memory (RAM) as the former case or a read only memory (ROM) as the latter case, for example.

The program storage section 23 is means for storing a program for providing the user with a Graphical User Interface (GUI) and so on of the picture recording device 20 and a program for searching the recording device 40 and the picture recording device 20 capable of executing the storing process and further obtaining the recording reservation information obtained from each of the devices and a free space of the HDD and so on to prioritize the devices, thereby selecting the device to which the storing process is asked, and can be realized by, for example, a hard disk drive (HDD), an optical disk, or a flash memory.

The motion picture data recording means 24 is means for obtaining picture and audio information by the broadcast receiving means 28 of the picture recording device 20, and storing the motion picture data 62 obtained by encoding the motion image of, for example, MPEG2, and can be realized by, for example, a hard disk drive (HDD), an optical disk, or a flash memory.

The motion picture data information recording means 25 is means for managing the program information such as so-called an Electronic Program Guide (EPG) obtained by the broadcast receiving means 28 of the picture recording device 20 and the list of the access destination information of the divided motion picture data 62 for every recorded program, and can be realized by, for example, a hard disk drive (HDD), an optical disk, or a flash memory.

The recording destination switching means 26 operates in response to a switching instruction by a program stored in the program storage section 23, and by sending the rest of the motion picture data 62, which has been transmitted to the motion picture data recording means 24 from the broadcast receiving means 28 via the recording destination switching means 26 and stored therein, to the motion picture data transmitting/receiving means 27, the rest of the motion picture data 62 on and after the switching timing can be transmitted to other picture recording device 20 or the recording device 40 via the network.

The motion picture data transmitting/receiving means 27 is capable of transmitting and receiving the motion picture to and from the picture recording device and the recording device on the network via the local area network (LAN) interface. The broadcast receiving means 28 has a function of receiving the broadcast, and is capable of encoding the received picture and audio information to form the motion picture data 62 of, for example, MPEG2. The generated motion picture data 62 is transmitted to the recording destination switching means 26 via the bus to determine the storage destination.

Equipment selection processing means 29 obtains the capacity of the HDD of the recording device and the recording reservation information of the picture recording device in order for selecting the recording device to which the storing process is asked, thus it becomes possible to select the recording device or the picture recording device which does not have recording reservation overlapping the program the storing process of which is to be asked and has the largest free area in the HDD.

Device information transmitting means 30 makes it possible to transmit the free area of the HDD capacity and the recording reservation information of the picture recording device or the recording device to the picture recording device as an information request source.

Further, the picture recording device is provided with motion picture data reproduction control means for controlling transfer of the motion picture data stored therein to the reproduction device issuing the transfer request. More specifically, in response to receiving the transmission request of the motion picture data to be reproduced for a unit corresponding to the program ID 65 in the picture recording data information management table 60 from the reproduction device 10, the motion picture data reproduction control means obtains the storage location of the URI of the motion picture data corresponding to the program ID 65 with reference to the access information 67, and transmits the motion picture data stored in this storage location to the reproduction device 10. The motion picture data reproduction control means, in the case in which the motion picture data is divided and stored, and two or more of the storage locations corresponding to the program ID 65 are set, controls reproduction of the motion picture data by either one of the reproduction methods described later in detail.

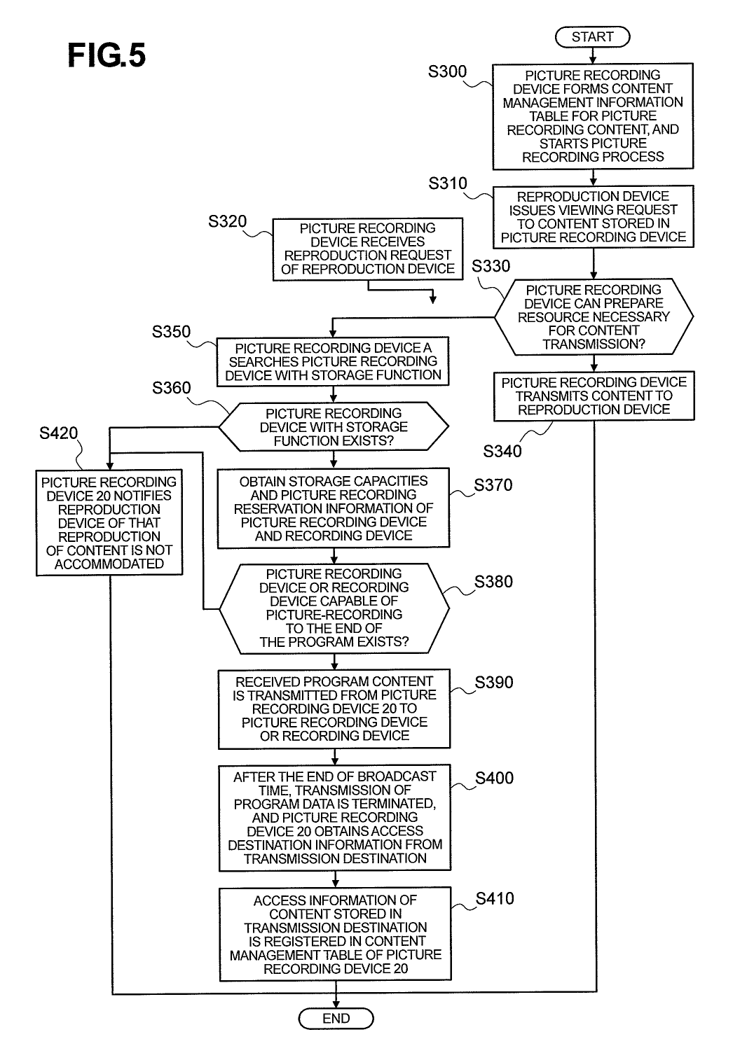

FIG. 5 is a flowchart to which the present embodiment can be applied. After the user asks picture recording reservation to the picture recording device 20, when the starting time of the picture recording reservation has been reached, the program information of the recording program is obtained from the EPG, the program ID corresponding to the recording program and the access destination information 67 of the destination on which the program is to be recorded for managing the motion picture data are generated, the motion picture data information management table 60 is generated, the table is registered to the motion picture data information management database (DB), thus starting the picture recording process (S300). On this occasion, it is assumed that the recording program is recorded on the motion picture data recording means 24 of the picture recording device 20, and the access destination information 67 is generated from the network address of the picture recording device 20 and a content ID for specifying the file of the recording program.

If a motion picture data delivery request is issued (S310) by the reproduction device 10 to the picture recording device 20 in the recording process, and the picture recording device 20 receives the content delivery request, whether or not the resource for delivery of the motion picture data can be prepared in the picture recording device 20 is judged (S330). Specifically, it is confirmed that the input/output load or the input/output rate of the HDD of the picture recording device 20 have not yet exceeded a predetermined value. Regarding the threshold value, it is possible to previously embed a value obtained by subtracting an amount of resources for delivering at least one piece of motion picture data from the resource capacity of the HDD as a fixed value before shipment of the picture recording device 20, or make the user set the threshold value providing a GUI for setting the threshold.

Since the delivery resource can be prepared in the case in which no picture recording reservation process or no motion picture data delivery process is executed, after transmitting the requested motion picture data, the flowchart is terminated (S340). Further, in the case in which the motion picture data delivery process has already been started and the delivery resource is lacking although the picture recording process is not in progress, an error code is transmitted to the reproduction device 10, and the flowchart is terminated.

In the case in which the picture recording reservation has already been registered in S330, the storing destination of the motion picture data is changed while continuing the broadcast receiving process in order for reducing the load on the disk drive. A detailed explanation will hereinafter be presented. Firstly, the picture recording devices 20 and the recording devices 40 capable of accommodating the storing process of the motion picture data are searched via the network. Although the searching method is not particularly limited, in the case of executing in the UPnP, the devices capable of moving the motion picture data are searched in the phase of the device description (S350).

In the case in which no device capable of accommodating the storing process exists as a result of searching the picture recording devices and the recording devices, the reproduction device 10 is notified of the fact that the resource for the motion picture data delivery has been failed to be provided, and then the process is terminated (S360).

In the case in which one or more of such picture recording devices 20 or such recording devices 40 exist on the network as a result of the search, the free area in the capacity of the HDD which can be used for storing the data is obtained from each of the devices obtained as the search result (S370).

The picture recording reservation information is further obtained from each of the picture recording devices picked up in the search. Further, if possible, the picture recording devices can transmit only the reservation information of the program around the recording program, which is presently recorded in the picture recording device 20, to the picture recording device 20.

The picture recording device 20 confirms the capacity of the HDD of each of the recording devices and the picture recording devices thus obtained, obtains an approximate value of the necessary capacity of the HDD from the bit rate of the motion picture data presently recorded and the rest of the period of the program, and performs comparison with the necessary capacity of the HDD. The picture recording device 20 then checks off the devices with shorter capacity of HDD, and arranges the devices capable of providing the necessary HDD capacity in the descending order of the HDD capacity in which the picture recording is possible to form a transmission destination candidate list. Further, in the case in which the device including the target device includes the picture recording device, the picture recording reservation information overlapping the presently recorded program in the recording period is searched, and the picture recording devices satisfying this condition are checked off, thus the transmission destination candidate list is formed. Through the process described above, the recording device or the picture recording device with the largest HDD capacity is determined as the transmission destination (S380).

When the motion picture data transmission destination is determined, the picture recording process to the HDD of the picture recording device 20 is terminated, and it is arranged to transmit the received motion picture data to the recording device or the picture recording device thus determined based on the search result to store the data therein (S390). When the broadcast period of the program presently recorded has elapsed, the picture recording device 20 terminates the transmission of the motion picture data, and obtains the access destination information of the transmitted motion picture data from the transmission destination (S400). The picture recording device 20 registers the access destination information of the divided motion picture data thus obtained to the motion picture data information management table formed in S300, and the flowchart is terminated (S410).

On this occasion, in the case in which the resource condition of the recording device or the picture recording device to which the motion picture data has been transmitted has changed to disable the transmission and recording of the motion picture data, the picture recording device 20 of the transmission source is notified of stop of transmission, and is also notified of the access destination information of the picture recording data already stored therein.

The picture recording device 20, when receiving the notification of the stop of transmission from the recording device or the picture recording device of the transmission destination, registers the access destination information of the already stored picture recording data to the motion picture data information management table, and at the same time, selects the recording device or the picture recording device to which the transmission is subsequently performed, and then continues transmission of the motion picture data.

The recording device or the picture recording device to which the transmission is subsequently performed is assumed to be the recording device or the picture recording device listed in the second position of the transmission destination candidate list formed by searching before starting the transmission. Further, it is also possible to execute the process in S380 described above once again to search the recording device or the picture recording device of the transmission destination.

Although in the process of S330 an example of making the judgment based on the resource value of the HDD is explained, in the case in which the delivery of the motion picture data is performed after executing recoding or the case in which the delivery of the motion picture data is performed after executing encryption, a lot of resource of the CPU 21 is also required, and therefore it is possible to make the judgment based on the overall system resources of the picture recording device 20.

Further, the resource value for each kind of motion picture data is set previously, the delivery resource value to be the delivery target is added to the present resource value of the picture recording device 20 in response to a delivery request, and the judgment can be made based on whether or not the obtained value exceeds the maximum resource value of the picture recording device 20, instead of the judgment by the comparison with the threshold value.

A method of reproducing the divided motion picture data with the reproduction device 10 based on the motion picture data information management table 60 will hereinafter be described. Firstly, a method of providing a play list to the reproduction device 10 by the picture recording device 20 will be explained.

In order for selecting the motion picture data stored in the picture recording device 20 from the reproduction device 10, the reproduction device 10 obtains a list of the motion picture data information. The motion picture data information is added with the URI for accessing the motion picture data, and when the motion picture data is elected from the list of the motion picture data information, reproduction of the motion picture data is started using the URI. On this occasion, by adding two or more of the URI provided as the motion picture data information, the reproduction device 10 can obtain all of the access destinations of the divided motion picture data. The reproduction device 10 reproduces the data sequentially along the list of the URI thus added thereto, thereby making it possible to reproduce all of the motion picture data.

Subsequently, a method of reproducing the data by the reproduction device after the data is redirected by the picture recording device 20 will be explained. When the reproduction device 10 reproduces the motion picture data divided and stored in two or more of the devices, by obtaining the motion picture data in the order of the access destination of the motion picture data information on the picture recording device 20 for managing the motion picture data information, and transmitting the motion picture data to the reproduction device 10 in real time, it becomes possible for the reproduction device 10 to reproduce the motion picture data as single motion picture data. In this case, the URI of the motion picture data added to the list of the motion picture data information obtained by the reproduction device 10 is unique.

Subsequently, a method of reproducing the data by the reproduction device after the picture recording device 20 links the motion picture data will be explained. Prior to the reproduction device 10 accessing the motion picture data, the motion picture data divided and stored in two or more of the devices is moved to the HDD of the picture recording device 20, and linked to generate single motion picture data. It is assumed that regarding obtaining and linking of the motion picture data, the linking operation is performed when the recording device or the picture recording device, which records the last one of the divided motion picture data, notifies, at the time point when the picture recording is finished, the picture recording device 20 of the fact that the picture recording is finished, or the linking operation is performed in a time zone when the user does not use the device.

What is claimed is:

1. A picture system for performing recording and reproducing of motion picture data via a network, comprising:
a first picture recording device for performing one of reception and recording of motion picture data;
a second picture recording device for performing one of reception and recording of motion picture data;
a reproduction device for performing reproduction of the motion picture data recorded in one of the first and second picture recording devices;
a network for connecting the first picture recording device, the second picture recording device, and the reproduction device, and performing communication of the motion picture data;
a motion picture data information recording section for storing a motion picture data information management table for recording a recording location of picture recording data for each of the picture recording data;
a motion picture data storage control section, in response to a reproduction request of the motion picture data stored in the first picture recording device from the reproduction device while the first picture recording device is receiving the motion picture data and performing recording, for transferring the motion picture data, which the first picture recording device receives on and after the reproduction request, to the second picture recording device, recording the motion picture data in the second picture recording device, and updating the recording location of the picture recording data in the motion picture data information management table.

2. The picture system according to claim 1,
wherein the first picture recording device includes motion picture data reproduction control means for, when the reproduction device requests the motion picture data to the first picture recording device in order for performing reproduction of the motion picture data recorded in the first picture recording device, obtaining access information representing the recording location of the motion picture data to be reproduced with reference to the motion picture data information management table and notifying the reproduction device of the access information, and
the reproduction device obtains the motion picture data based on the access information notified from the motion picture data reproduction control means, and reproduces the motion picture data.

3. The picture system according to claim 1,
wherein the first picture recording device includes motion picture data reproduction control means for, when the reproduction device requests the motion picture data to the first picture recording device in order for performing reproduction of the motion picture data recorded in the first picture recording device, obtaining access information representing the recording location of the motion picture data to be reproduced with reference to the motion picture data information management table, obtaining the motion picture data based on the obtained access information, and reproducing the motion picture data, and
the reproduction device obtains the motion picture data notified from the motion picture data reproduction control means, and reproduces the motion picture data.

4. The picture system according to claim 1,
wherein the first picture recording device includes motion picture data reproduction control means for, prior to the reproduction device requests the motion picture data to the first picture recording device in order for performing reproduction of the motion picture data recorded in the first picture recording device, obtaining access information representing the recording location of the motion picture data to be reproduced with reference to the motion picture data information management table, obtaining the motion picture data from two or more of the recording locations based on the access information, and linking the obtained motion picture data to perform correction of the motion picture data.

5. The picture system according to claim 1,
wherein the motion picture data storage control section judges a processing load condition of the first picture recording device, and controls the first and second picture recording devices so that the motion picture data received by the first picture recording device is transferred to the second picture recording device and recorded in the second picture recording device in the case in which transmission of the motion picture data in response to a reproduction request from the second picture recording device is not accommodated.

6. The picture system according to claim 5,
wherein the motion picture data storage control section obtains device condition information from the second picture recording device, and judges whether or not the transmission of the motion picture data is accommodated.

7. The picture system according to claim 6,
wherein the device condition information obtained from the second picture recording device is mainly composed of picture recording reservation information of the second picture recording device and a remaining recording amount of the motion picture data.

8. The picture system according to claim 7,
wherein the motion picture data storage control section obtains a necessary recording capacity from a bit rate of the motion picture data presently recorded and a remaining program period, compares the necessary recording capacity with the remaining recording capacity in the device condition information to judge whether or not recording finish time of the motion picture data presently recorded corresponds to a recording time zone of the picture recording reservation information of the device condition information, and determines whether or not the transmission of the motion picture data to the second picture recording device is accommodated.

9. The picture system according to claim 1,
wherein the access information for representing the recording location of the motion picture data to be reproduced includes a URI.

10. A picture recording and reproducing method of a picture system capable of performing recording and reproducing of motion picture data via a network, comprising the steps of:
recording received motion picture data in a first picture recording device;
performing reproduction request of the motion picture data stored in the first picture recording device from a reproduction device to the first picture recording device via the network;
transferring the motion picture data received by the first picture recording device to a second picture recording device on and after receiving the reproduction request;
adding a recording location of the motion picture data transmitted to and recorded in the second picture recording device to a recording location of picture recording data in a motion picture data information management table for recording the recording location of the picture recording data for each picture recording data; and
transferring the motion picture data requested by the reproduction device to the reproduction device.

11. A picture recording and reproducing method for performing recording and reproducing of motion picture data via a network, comprising the steps of:
forming a content management information table for setting address information representing a recording location of a motion picture content to be recorded;
receiving a reproduction request of the stored picture recording content via the network;
judging whether or not a necessary resource for transmission of the picture recording content to which the reproduction request is issued can be prepared;
transmitting the picture recording content to which the reproduction request is issued to a source of the request when the resource can be prepared;
stopping recording of the motion picture content when the resource is failed to be prepared and transferring the rest of the motion picture content to another picture recording device connected to the network;
obtaining access information representing the recording location of the motion picture content from the another picture recording device connected to the network upon termination of the picture recording of the motion picture content; and
adding the access information of the another picture recording device to the content management information table.

12. The picture recording and reproducing method according to claim 11, further comprising the steps of:
obtaining, in response to receiving the reproduction request of the stored picture recording content via the network, the address information at the start of picture recording corresponding to the picture recording content to which the reproduction request is issued and the address information of the transmission destination of the motion picture content from the content management information table; and
transmitting the address information obtained from the content management information table to the source of the reproduction request.

13. The picture recording and reproducing method according to claim 11, further comprising the steps of:
obtaining, in response to receiving the reproduction request of the stored picture recording content via the network, the address information at the start of picture recording corresponding to the picture recording content to which the reproduction request is issued and the address information of the transmission destination of the motion picture content from the content management information table;
obtaining the stored picture recording content based on the address information; and
transmitting the picture recording content to the source of the reproduction request.
